(19) United States
(12) Patent Application Publication
(10) Pub. No.: US 2026/0236300 A1
(43) Pub. Date: Aug. 13, 2026

(54) MANAGING WORKLOADS IN AN INTEGRATED CIRCUIT FOR VOLTAGE REGULATOR MODULE PHASE REDUCTION

(71) Applicant: INTERNATIONAL BUSINESS MACHINES CORPORATION, Armonk, NY (US)

(72) Inventors: Justin E. Henspeter, Georgetown, TX (US); Eric Jason Fluhr, Leander, TX (US); Gregory Scott Still, Raleigh, NC (US); Eric Marz, Williston, VT (US)

(21) Appl. No.: 19/049,658

(22) Filed: Feb. 10, 2025

(51) Int. Cl. G06F 9/48

(52) U.S. Cl. CPC G06F 9/4893

(57) ABSTRACT

Managing workloads in an integrated circuit (IC) for voltage regulator module (VRM) phase reduction includes detecting, by a first core set of the IC, a number of operable phases of a VRM providing power to the first core set. The number of phases is compared with a threshold number of operable phases defined in the IC. In response to determining that the number of operable phases is less than the threshold number of operable phases, one or more operations performed by the first core set are offloaded to one or more second core sets of the integrated circuit.

### BACKGROUND

This disclosure relates to managing workloads in an integrated circuit and, more particularly, to managing workloads in an IC for voltage regulator module phase reduction.

Computer systems such as servers include one or more electronic components known as Voltage Regulator Modules (VRMs). Each VRM is configured to deliver voltage and current to one or more subsystems or components of the computer system (e.g., referred to herein as “a target subsystem”). A VRM, for example, may be used to provide the processor of the computer system with the voltage and current necessary for the processor, or a portion of the processor, to operate. Typically, the VRM is disposed on a circuit board (e.g., a motherboard) and may be positioned in proximity to the processor or processor socket to which the VRM is to provide power. In many computing systems, the VRM is designed as a pluggable component to facilitate replacement in the event the VRM experiences a fault or a failure.

To supply adequate voltage and current to the target subsystem, a VRM will include a plurality of phases. Should one or more of the phases of the VRM fail, the VRM may be unable to provide sufficient current to the target subsystem for normal operation or may render the target subsystem unusable altogether.

In some cases, a VRM may include more phases than needed to meet the power requirements of the target subsystem. With processors increasing in complexity, requiring larger numbers of distinct output voltages, and/or requiring larger currents, the number of phases included in VRMs continues to grow to meet these evolving needs. The number of phases needed is further increased depending on the amount of phase redundancy desired from the VRM. This makes VRMs increasingly complex and costly devices. The limited space available within computer systems and/or on circuit boards often constrains the size of the VRM leading to difficulties in physically packaging the number of phases needed into a single VRM.

### SUMMARY

In one or more embodiments, a method includes detecting, by a first core set of an integrated circuit (IC), a number of operable phases of a voltage regulator module (VRM) providing power to the first core set. The method includes comparing the number of operable phases with a threshold number of operable phases defined in the IC. The method includes, in response to determining that the number of operable phases is less than the threshold number of operable phases, offloading one or more operations performed by the first core set to one or more second core sets of the IC.

In one or more embodiments, an IC includes a first core set including one or more first cores. The first core set is capable of detecting a number of operable phases of a VRM providing power to the first core set. The IC includes one or more second core sets coupled to the first core set. Each of the one or more second core sets includes one or more second cores. The first core set is further capable of comparing the number of operable phases with a threshold number of operable phases. The first core set is capable of, in response to determining that the number of operable phases is less than the threshold number of operable phases, offloading one or more operations performed by the first core set to the one or more second core sets.

In one or more embodiments, a computer program product includes one or more computer readable storage media and program instructions stored on the one or more computer readable storage media to perform operations. The operations include detecting, by a first core set of an IC, a number of operable phases of a VRM providing power to the first core set. The operations include comparing the number of operable phases with a threshold number of operable phases defined in the IC. The operations include, in response to determining that the number of operable phases is less than the threshold number of operable phases, offloading one or more operations performed by the first core set to one or more second core sets of the IC.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an integrated circuit (IC) in accordance with one or more embodiments of the disclosed technology.

FIG. 2 illustrates an IC in accordance with one or more other embodiments of the disclosed technology.

FIG. 3 illustrates a method of offloading workloads for an IC in accordance with one or more embodiments of the disclosed technology.

FIG. 4 illustrates another IC 400 in accordance with one or more embodiments of the disclosed technology.

FIG. 5 illustrates an example of a computing environment that may be used with one or more embodiments of the disclosed technology.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to managing workloads in an integrated circuit (IC) and, more particularly, to managing workloads in an IC for voltage regulator module (VRM) phase reduction. In accordance with the inventive arrangements described within this disclosure, an IC of a computing system is capable of detecting the number of operable phases of a VRM supplying power to the IC. The IC may be, for example, a processor of the computing system. The IC may require, or be powered by, a plurality of VRMs. In cases where a number of operable phases of a VRM that supplies power to the IC is below a threshold number of operable phases (the “threshold number”), the IC is capable of initiating a remedial action. A VRM having a number of operable phases that is less than the threshold number may be referred to herein as a “disabled VRM.” The remedial action shifts or offloads workload(s) away from the portion of the IC powered by the disabled VRM to one or more other portions within the IC that are powered by VRM(s) that are not considered “disabled,” e.g., VRMs that have a number of operable phases greater than or equal to the threshold number.

In one or more embodiments, the IC is capable of offloading the workload(s) from one or more cores of the IC powered by the disabled VRM to one or more other cores of the IC powered by a different VRM that is not disabled. In one or more embodiments, the IC includes one or more cores that are reserved for use in performing workloads that have been offloaded from other cores powered by disabled VRMs. These reserved core(s) may remain unused until such time that workload(s) are offloaded. This capability allows the IC to continue to operate at a high or maximum rated level of performance as the reserved and previously dormant cores are activated to assume operations offloaded from other cores that receive power from a disabled VRM.

In one or more embodiments, the one or more cores from which operations are offloaded may be deactivated. The deactivation may occur subsequent to, e.g., responsive to, completion of the offloading. In one or more other embodiments, the one or more cores from which operations are offloaded may continue to operate albeit at a reduced capacity that requires an amount of current that still may be supplied by the disabled VRM. For example, the one or more cores may be throttled down to consume less current and an amount of current that the disabled VRM is still capable of providing given the number of operable phases included therein.

The inventive arrangements described within this disclosure allow for deferred replacement of the VRM(s) by shifting workload away from the particular core or cores that are supplied with power from a disable VRM. Further, the shifting of workload and the use of reserved core(s) allows the total number of required redundant phases for a given IC to be reduced while still maintaining equivalent availability of the IC/system and/or while continuing to provide full system performance.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Where considered appropriate, reference numbers are repeated among the figures to indicate corresponding, analogous, or like features.

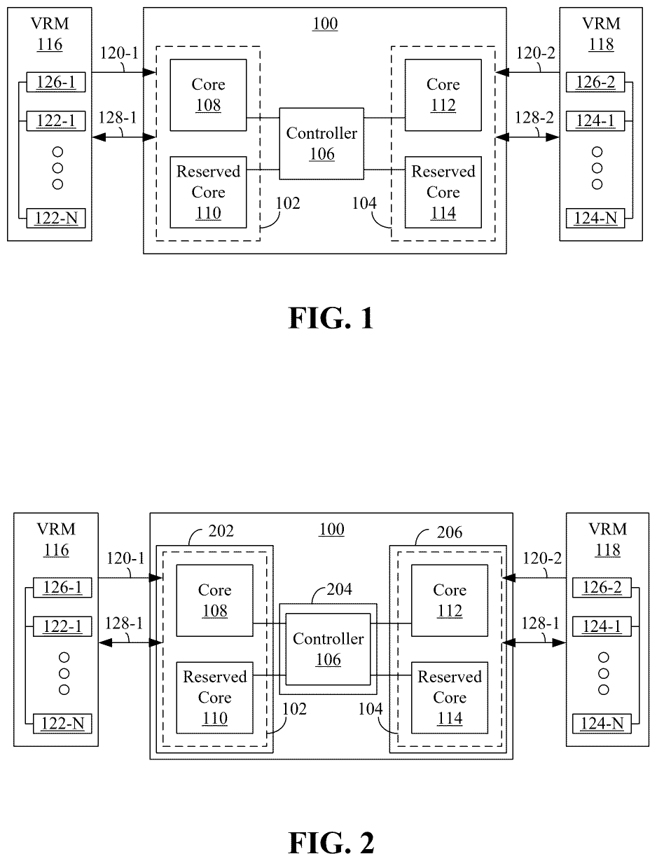

FIG. 1 illustrates an IC 100 in accordance with one or more embodiments of the disclosed technology. In the example of FIG. 1, IC 100 may be implemented as a processor that includes a plurality of cores. Each core is capable of executing program instructions. IC 100 may be implemented as any of a variety of different types of processors such as, for example, a central processing unit (CPU), a graphics processing unit (GPU), a digital signal processor (DSP), an Application-Specific IC (ASIC), or the like. IC 100 also may be implemented as a System-on-Chip. In the example of FIG. 1, IC 100 is implemented as a single die. That is, IC 100 may be implemented as a single package including a single die, where the die contains the various components illustrated in FIG. 1.

As shown, IC 100 includes a core set 102 (e.g., a first core set), a core set 104 (e.g., a second core set), and a controller 106. Core set 102 includes one or more cores illustratively shown as core 108. Core set 102 may include one or more reserved cores illustratively shown as reserved core 110. Core set 104 includes one or more cores illustrative shown as core 112. Core set 104 also includes one or more reserved cores illustratively shown as reserved core 114. Each core set may be differentiated from the other in that each core set receives power (e.g., voltage and current) from a different VRM. Core set 102 is powered by VRM 116 via power line 120-1. Core set 104 is powered by VRM 118 via power line 120-2.

Each of VRMs 116, 118 may be implemented as a multi-phase VRM. In the example, VRM 116 includes phases 122-1 through 122-N, where N is an integer value of 2 or more. VRM 118 includes phases 124-1 through 124-N. For purposes of illustration and not limitation, each of phase 122 and phase 124 may be implemented as a buck converter circuit. Further, as generally understood by those skilled in the art, each of VRM 116 and VRM 118 may include circuitry capable of electrically isolating adjacent ones of the phases from one another (not shown). With this implementation, when a phase does fail, the remaining operable phases of the VRM may continue to provide voltage and current to the target subsystem unaffected by the failed phase.

In one or more embodiments, each VRM 116 and VRM 118 may be implemented as a phase redundant VRM. A phase redundance VRM will include more phases than required to provide power to the target subsystem so that if one or more of the redundant phases fails, the VRM may continue to supply the required voltage and current to the target subsystem thereby allowing the target subsystem to continue operating uninterrupted and at full capacity.

As an illustrative and non-limiting example, if a target subsystem requires N phases, the VRM may include additional phases X that may be switched on to replace failed or failing ones of the N phases. If the IC includes multiple different rails R, it may be seen that R VRMs would be required. Each VRM would provide N+X phases to provide redundancy resulting in an additional R*X phases. With this in mind, reducing the need for redundancy and/or even delaying the need to replace a VRM can be beneficial in terms of reduced system complexity and the ability to the computer system to continue operation.

In cases where VRM 116 and VRM 118 are not redundant, each VRM includes N phases where N is the minimum number of operable phases required by each of core set 102 and core set 104. In this example, N may also be the threshold number of operable phases. Accordingly, each of VRM 116 and VRM 118 includes only the minimum number of phases needed to meet the voltage and current requirements of the target core set of that VRM. In this example, if either VRM 116 or VRM 118 loses a single phase, that VRM will no longer be able to meet the minimum requirements of its target core set as the VRM will include fewer operable phases than needed.

In cases where VRM 116 and VRM 118 are redundant multiphase VRMs, each of VRM 116 and VRM 118 will include more phases than necessary to meet the voltage and current requirements of the particular core set to which each VRM provides power. In that case, referring to FIG. 1, each of core set 102 and core set 104 may require a minimum number of operable phases plus one or more additional (redundant) phases still collectively illustrated as N phases. In this example, each of VRM 116 and VRM 118 may lose each of the additional/redundant phases and still provide the minimum voltage and current required to the respective core set.

In the example of FIG. 1, each of VRM 116 and VRM 118 includes a VRM controller 126. As shown, VRM 116 includes VRM controller 126-1. VRM 118 includes VRM controller 126-2. Each VRM controller 126 is capable of monitoring the phases therein to generate a count of the phases within the VRM that are operable. An operable phase is a phase that is capable of providing voltage and current in compliance with the specification of the VRM. An inoperable phase is a phase that is not able to provide voltage and current in compliance with the specification for the VRM. Each VRM controller 126 may be polled by the core set to which power is provided (e.g., the target core set). For example, core set 102 is capable of polling VRM controller 126-1 over communication link 128-1. VRM controller 126-1 is capable of responding over communication link 128-1 with a count of operable phases 122 therein. Core set 104 is capable of polling VRM controller 126-2 over communication link 128-2. VRM controller 126-2 is capable of responding over communication link 128-2 with a count of operable phases 124 therein. In one or more embodiments, communication links 128 may be implemented as Power Management Buses.

In the example, reserved core 110 and reserved core 114 may be differentiated from other cores within the respective core sets 102, 104 in that reserved cores 110, 114, under normal operating conditions, are not utilized to perform workloads. A workload refers to one or more operations that are executed by a core. For example, while each of VRM 116 and VRM 118 is operating with at least the threshold number of operable phases, reserved cores 110, 114 may remain dormant (e.g., not executing any workload). Reserved cores 110, 114 are only used in response to a workload being offloaded or shifted from one or more cores of a different core set due to a disabled VRM.

For example, consider the case in which the number of operable phases 122 of VRM 116 falls below the threshold number of operable phases. In that case, a workload may be offloaded from core set 102 to core set 104. This offloading may be performed so long as VRM 118 has a number of operable phases 124 greater than or equal to the threshold number. The workload offloaded from core set 102 may be provided to, or executed by, reserved core 114 of core set 104. The process may work in the reverse in that a workload may be offloaded from core set 104 to reserved core 110 of core set 102 in response to VRM 118 having less than the threshold number of operable phases.

In the examples, the threshold number of operable phases may be a parameter that is set or programmed into IC 100. The threshold number, for example, may be set in a configuration register of IC 100 and may be modified or updated from time to time including during operation in the field. In one or more embodiments, each core set may include or have a core set specific threshold number such that the threshold number of core set 102 may differ from the threshold number of core set 104. In one or more embodiments, the threshold number may be the minimum number of phases needed for operation of the target core set to operate at full capacity. In one or more embodiments, the threshold number may be the minimum number of phases needed for operation of the target core set to operate at full capacity including any reserved cores therein operating at full capacity. For example, the threshold may be set to N phases. In one or more other embodiments, the threshold number may be set to N plus a specified number of additional phases.

In one or more embodiments, controller 106 is capable of executing firmware to manage various processes within IC 100. Controller 106 may be supplied with power by yet another VRM (not shown). In the example, controller 106 may include interconnect circuitry to facilitate communications between core set 102 and core set 104.

FIG. 2 illustrates IC 100 in accordance with one or more other embodiments of the disclosed technology. IC 100 of FIG. 2 may be implemented substantially the same as IC 100 of FIG. 1. In the example of FIG. 2, however, IC 100 is implemented as a multi-die IC. As shown, each of core set 102, controller 106, and core set 104 is disposed or implemented in a different die. Within this disclosure, the term “die” may refer to a chiplet. The dies may be coupled to one another by way of any of a variety of different interconnect technologies such as bridge dies, interposers, or the like. The particular manner in which the dies are coupled is not intended as a limitation of the inventive arrangements.

For example, core set 102 is implemented in die 202. Controller 106 is implemented in die 204. Core set 104 is implemented in die 206. In the example, each of die 202 and die 204 is supplied with power by a different VRM. In one or more embodiments, die 204 may be supplied with power by yet another VRM (not shown).

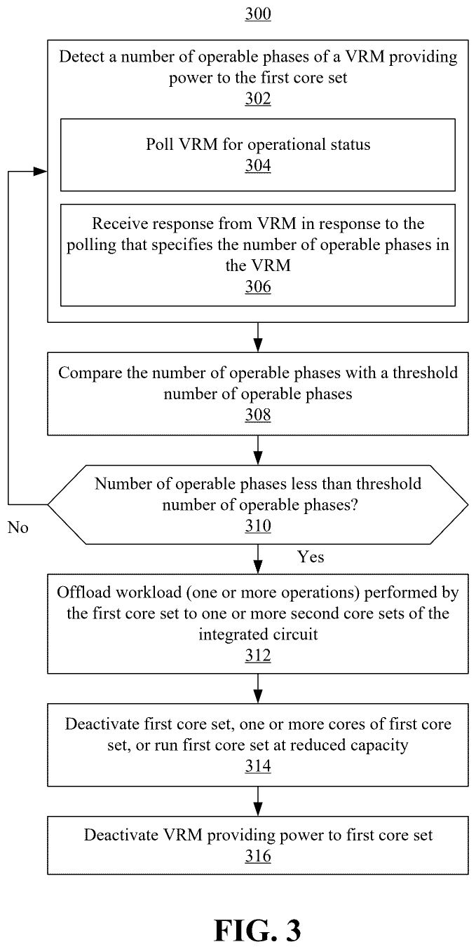

FIG. 3 illustrates a method 300 of offloading workloads for an IC in accordance with one or more embodiments of the disclosed technology. Method 300 may be performed by IC 100 of FIG. 1 and/or FIG. 2. Method 300 is described from the perspective of the first core set. It should be appreciated that each core set is capable of performing the operations described in connection with FIG. 3 in parallel. In this regard, the offloading, or the initiating of offloading, may be performed from core set 102 to core set 104 or in the reverse direction where core set 104 offloads to core set 102. In cases where more than two core sets are included in the IC, the offloading may offload operations, or initiate offloading of operations, from any core set having a disabled VRM to any other core set having a VRM that is not disabled (e.g., having a number of operable phases greater than or equal to the threshold number). The threshold number may be the same across all core sets (e.g., where the core sets are identical) or specific (and potentially different) from one core set to another so long as the VRM of each core set is capable of supplying sufficient voltage and current to the core set including the reserved core(s) in the event that such cores are needed.

In block 302, core set 102 is capable of detecting a number of operable phases of the VRM 116 that provides power to the first core set. For example, in block 304, core set 102 is capable of detecting the number of operable phases of VRM 116 by polling VRM 116 for operational status via communication link 128-1. In block 306, in response to the polling, core set 102 receives a response from VRM 116 that specifies the number of operable phases 122 therein.

The polling described accounts for the reality that each core set, or IC 100, has no knowledge of the number of phases that are available in the VRMs or that are used to provide power. By having each VRM respond to core set polling with the number of operable phases therein, each core set is capable of determining whether remedial action is necessary. For example, the VRM may or may not have redundant phases. While IC 100 may be able to evaluate the sufficiency of current received from a given VRM, IC 100 is unaware of the number of phases used to provide that current and whether the VRM still has an acceptable number of operable phases therein for reliable and/or uninterrupted operation of IC 100 without the VRM informing the core set of that information. In this regard, the number of operable phases of a VRM is not equivalent to the VRM simply indicating a fault, which provides no indication as to the number of operable phases left or remaining in the VRM.

Providing IC 100 with an actual count of operable phases provides a mechanism for ensuring reliable and/or uninterrupted operation because IC 100 is capable of taking remedial action proactively or predictively. For example, depending on how the threshold number of operable phases is defined in IC 100, a core set may offload a workload when a level of phase redundancy of the VRM falls below a defined level or in cases where the VRM provides no phase redundancy and a single phase therein has failed.

In block 308, core set 102 is capable of comparing the number of operable phases of VRM 116 with a threshold number of operable phases defined in IC 100. In block 310, core set 102 determines whether the number of operable phases of VRM 116 is less than the threshold number. In response to determining that the number of operable phases is less than the threshold number of operable phases, method 300 continues to block 312. In response to determining that the number of operable phases is not less than the threshold number of operable phases, method 300 loops back to block 302 to continue monitoring the number of operable phases of VRM 116.

In block 312, core set 102 is capable of offloading one or more operations performed by core set 102 to one or more second core sets such as core set 104 of IC 100. The one or more second core sets receive power from one or more second VRMs each including a number of operable phases that is greater than or equal to the threshold number of operable phases. In some examples, once a workload is shifted away from a core set or particular cores of a core set, the workloads may remain shifted and IC 100 may continue to operate as described until the disabled VRM is replaced.

As discussed, each of the one or more second core sets includes one or more reserved cores (e.g., reserved core 114). Each reserved core is reserved for performing operations offloaded from another core set supplied with power from a disable VRM. When not in use, the reserved cores may be powered down, put in a low power or sleep mode, or the like. As part of block 312, the one or more operations are offloaded to the one or more reserved cores. The reserved cores may be powered up or otherwise activated prior to offloading of any operations thereto.

In one or more embodiments, core set 102 and core set 104 may communicate with one another to negotiate the offloading of operations. In one or more other embodiments, core set 102 may notify controller 106 that VRM 116 is disabled. In response, controller 106 may coordinate the offloading of operations from core set 102 to core set 104.

The amount of work offloaded from core set 102 to core set 104 also may vary. In one or more examples, one or more operations of a larger subset of operations performed by cores 108 of core set 102 may be offloaded (e.g., some operations from one or more or all cores, but not all operations are offloaded). In one or more other examples, all operations performed by core set 102 are offloaded. In one or more other examples, all operations performed by each core of a subset of the total number of cores 108 of core set 102 are offloaded.

In one or more embodiments, the particular offloading strategy may be defined in configuration registers and/or memory of IC 100 and may depend on the particular operating context of IC 100. In one or more embodiments, the offloading strategy may be implemented by a hypervisor that executes in IC 100 across the cores therein. In some cases, for example, it may be desirable to allow core set 102 to continue operating albeit at a reduced capacity such that less current is required. In that case, cores may be throttled down to provide less performance or a subset of the cores 108 may be deactivated while others of core set 102 continue to operate. In other cases, the entirety of core set 102 may be deactivated or powered down.

As noted, the shifting or offloading of a workload from a core set may involve operation of a hypervisor. For purposes of illustration, firmware executing in controller 106 may receive an indication from a core set that the VRM supplying power to the core set has less than the threshold number of operable phases. The firmware may signal the hypervisor that workload needs to be offloaded from the core set with the disabled VRM. The hypervisor is capable of performing any tracking that is necessary of the other core sets (whether each has a VRM with at least the threshold number of operable phases) and whether such core sets include reserved core(s) and/or the reserved core(s) if included are available to take on a workload or portion of the workload. The hypervisor may select the particular core set and reserved core(s) therein to assume the workload. The hypervisor, for example, may activate the selected reserved core(s) and move the workload. Further, the hypervisor may perform functions such as turning off cores and/or throttling cores as described herein.

As an illustrative and non-limiting example, the information described herein (e.g., referred to as “power subsystem information”) that may specify the number of operable phases for a given core set and/or a decision/detection that offloading is needed for the given core set in reference to the core set being impacted by the loss of VRM capability may be provided to the hypervisor. In response to this information, the hypervisor, which may be the entity in control of work scheduling to the cores, is capable of implementing its own specific offloading process/technique to move the work (e.g., one or more operations) from one core set to another. It should be appreciated that the particular core set to which operations are offloaded may be selected based on any of a variety of different factors that may include, for example, but are not limited to, memory footprint localization, memory or I/O subsystem failures, high availability workload cloning, or the like. In any case, this process may run on the affected core set having the disabled VRM with the process removing itself from that core set in response to the offloading. In another aspect, the movement of the workload may be performed by another core set to stop the affected core set with the hypervisor restarting the workload in a different core set.

Accordingly, in block 314, once offloading of the workload to core set 104 is complete, one or more cores of the first core set are optionally deactivated in response to completion of the offloading. In another example, in block 314, core set 102 is entirely deactivated in response to completion of the offloading. In another example, in block 314, core set 102 is throttled back to operate at a reduced capacity and/or in a safe mode. Any of the full and/or partial deactivations described may be performed for core set 102. In one or more embodiments, the hypervisor is capable of throttling core set 102, deactivating core(s) of core set 102, and/or deactivating the entirety of core set 102.

In block 316, the hypervisor is capable of optionally deactivating VRM 116. For example, the hypervisor, which may execute across cores of the core sets of IC 100, is capable of deactivating VRM 116 in cases where the entirety of core set 102 is deactivated. Otherwise, while one or more cores 108 of core set 102 are permitted to operate, the hypervisor may permit VRM 116 to continue to operate.

In one or more embodiments, the particular offloading strategy and/or power strategy for the core set (and/or cores therein) and the disabled VRM may depend on the degree of disablement of the VRM. For example, the offloading and/or power strategy may be determined based, at least in part, on the number of operable phases in the disabled VRM. As an illustrative and non-limiting example, the hypervisor may maintain a table, decision tree, or other data structure specifying an offload and power strategy for the core set and the disabled VRM. For a given number of operable phases that is less than the threshold number, the hypervisor, which may receive the number of operable cores from the core set(s) and/or controller 106, may select different strategies. Examples of these strategies may be offloading all operations from the entire core set thereby allowing the entire core set and the disabled VRM to be powered down (e.g., when the number of operable phases is below a lower threshold), offloading some operations from one or more cores of the core set thereby allowing the cores of the core set to be throttled down while the disabled VRM continues to operate (e.g., in cases where the number of operable phases permits such operation), and/or offloading all operations for only selected (e.g., subset of) cores of the core set thereby allowing the inactive cores to be powered down while the disabled VRM continues to operate (e.g., in cases where the number of operable phases permits such operation).

In one or more embodiments, VRM 116 is capable of sending a message indicating that VRM 116 requires replacement. The message may be generated and sent in response to VRM controller 126-1 detecting one or more failed phases therein.

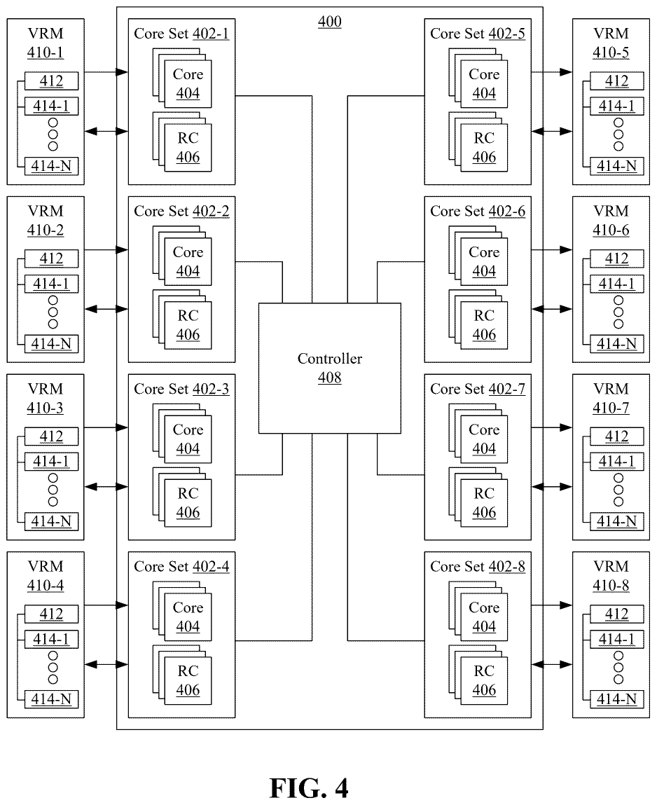

FIG. 4 illustrates another IC 400 in accordance with one or more embodiments of the disclosed technology. IC 400 of FIG. 4 may be implemented similar to the examples of FIGS. 1 and 2. The example of FIG. 4 illustrates a larger and more complex IC. IC 400 includes a plurality of core sets 402 illustrated as core sets 402-1, 402-2, 402-3, 402-4, 402-5, 402-6, 402-7, and 402-8. Each core set 402 includes one or more cores 404 and one more reserved cores 406. Cores sets 402 may be coupled through controller 408. Each core set 402 receives power from a core set-specific VRM 410 illustrated as VRMs 410-1, 410-2, 410-3, 410-4, 410-5, 410-6, 410-7, and 410-8. Each VRM may include a VRM controller 412 and a plurality of phases 414-1 through 414-N.

In one or more embodiments, IC 400 is implemented as a single die. In one or more other embodiments, IC 400 is implemented using a plurality of dies/chiplets where each core set 402 and controller 408 is implemented a plurality of dies (e.g., each in an individual die).

In one or more embodiments, the decision as to which core set is to receive the workload offloaded from another core set as a result of the VRM of the core set having fewer than the threshold number of operable phases may be based on one or more different factors. In addition to those discussed herein or in the alternative, for example, a core set that receives power from a VRM that does not have at least the threshold number of operable phases is not considered as a candidate for receiving the workload. Such core set is excluded from consideration and will not receive the offloaded workload. In another example, in addition to those factors discussed herein or in the alternative, a core set whose reserved cores are in use is also not considered as a candidate for receiving the workload. Such a core set is excluded from consideration and will not receive the offloaded workload. In one or more other examples, the workload may be distributed among reserved cores of a plurality of different core sets. In either case, the reserved cores are capable of taking on the incremental workload and the VRMs attached to the core sets with reserved cores taking on the offloaded workload are capable of handling the incremental increase in power requirements. The foregoing factors may be considered individually or in any combination.

In one or more embodiments, a hypervisor may be notified of the need to offload a workload by way of firmware executing in controller 408 and handle the offloading as previously described. The need for firmware may be implementation dependent. In one or more examples, the hypervisor may have direct access to the VRM phase state for each core set such that the hypervisor is capable of detecting when a VRM is at least partially inoperable or disabled and, in response make the offload decision. In other examples, controller 106 executing firmware may read the VRM phase state and decide whether the phases meet the thresholds/criteria described herein and, in response, notify the hypervisor of this situation so that the hypervisor may perform the offloading operations described herein.

The inventive arrangements described within this disclosure provide the various technological benefits discussed. In addition, the example implementations prevent overcurrent conditions. An overcurrent condition arises in cases where an IC, or a subsystem of the IC such as a core set, attempts to draw more current from a VRM than the VRM is capable of providing. Such a condition may arise in cases where the VRM has one or more failed phases therein and the IC is attempting to pull more current than the remaining operable phases are capable of providing. The IC, or subsystem thereof, if aware of the number of available phases in accordance with the examples described herein, may be shut down, have a workload offloaded therefrom, and/or operate at a reduced capacity to avoid drawing too much current from the disabled VRM and causing a system crash or other failure. This avoids the overcurrent condition.

The inventive arrangements, by providing the predictive capability of a total VRM failure, further allows for VRMs to include fewer phases than is currently the case. That total number of phases, e.g., redundant phases, may be reduced while maintaining equivalent availability and maintaining full system performance.

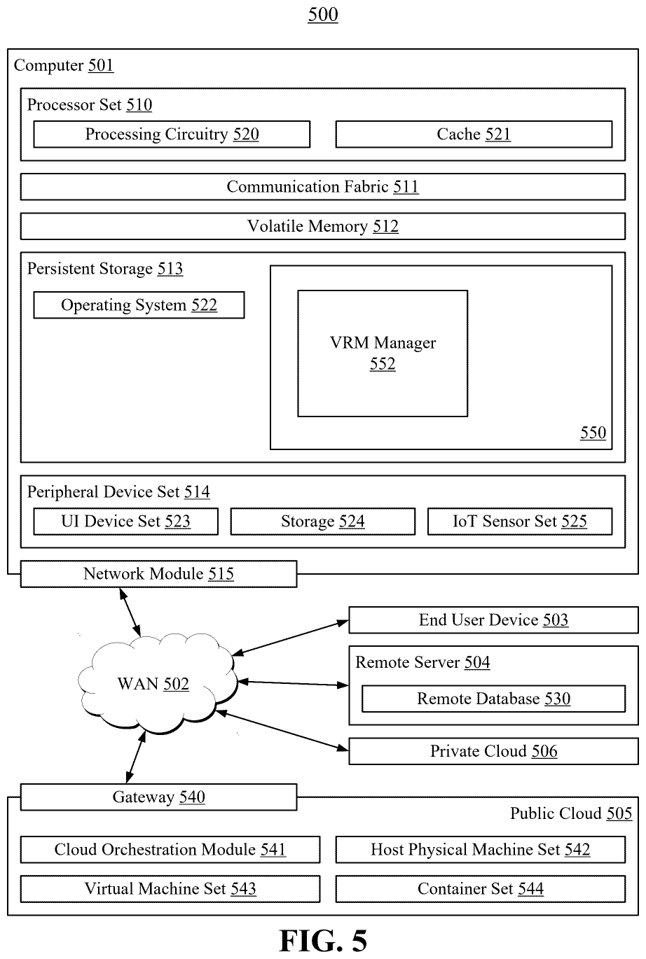

FIG. 5 illustrates an example of a computing environment 500 that may be used with one or more embodiments of the disclosed technology. Computing environment 500 contains an example of an environment for the execution of at least some of the computer code in block 550 involved in performing the inventive methods, such as VRM manager 552. VRM manager 552 is capable of, upon execution, polling VRM(s) for the number of operable phases therein, comparing the number of operable phases received from the VRM(s) with the threshold number, and interacting with firmware and/or a hypervisor to effectuate the offloading of workloads as described herein.

In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544. Computer 501 may include a hypervisor (not shown).

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing. As an illustrative and non-limiting example, processor set may include one or more processors such as any of the example ICs described herein in connection with FIGS. 1, 2, and/or 4. Each such IC (e.g., processor) may receive power from one or more VRMs (not shown).

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

Communication fabric 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code included in block 550 typically includes at least some of the computer code involved in performing the inventive methods.

Peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (e.g., where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (e.g., embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 503 is any computer system that is used and controlled by an end user (e.g., a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The terminology used herein is for the purpose of describing particular embodiments only and is not intended to be limiting. Notwithstanding, several definitions that apply throughout this document now will be presented.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the terms “in response to” and “responsive to” mean responding or reacting readily to an action or event. Thus, if a second action is performed “in response to” or “responsive to” a first action, there is a causal relationship between an occurrence of the first action and an occurrence of the second action. The term “responsive to” indicates the causal relationship. In some cases, other terms such as “if,” “when,” or “upon” are used and also convey a causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
detecting, by a first core set of an integrated circuit, a number of operable phases of a voltage regulator module (VRM) providing power to the first core set;
comparing the number of operable phases with a threshold number of operable phases defined in the integrated circuit; and
in response to determining that the number of operable phases is less than the threshold number of operable phases, offloading one or more operations performed by the first core set to one or more second core sets of the integrated circuit.

2. The method of claim 1, wherein the detecting the number of operable phases of the VRM comprises:
polling the VRM for operational status; and
in response to the polling, receiving a response from the VRM specifying the number of operable phases therein.

3. The method of claim 1, wherein the one or more second core sets receive power from one or more second VRMs each including a number of operable phases that is greater than or equal to the threshold number of operable phases.

4. The method of claim 1, wherein each of the one or more second core sets comprises one or reserved cores; and
wherein each reserved core is reserved for performing operations offloaded from another core set supplied with power from a VRM having a number of operable phases that is less than the threshold number of operable phases.

5. The method of claim 4, wherein the one or more operations are offloaded to the one or more reserved cores.

6. The method of claim 1, wherein the one or more operations are at least one of a subset of operations performed by one or more cores of the first core set, all operations performed by the first core set, or all operations performed by each core of a subset of cores of the first core set.

7. The method of claim 1, wherein the first core set operates at a reduced capacity in response to determining that the number of operable phases is less than the threshold number of operable phases.

8. The method of claim 1, wherein one or more cores of the first core set are deactivated in response to completion of the offloading.

9. The method of claim 1, wherein the first core set is entirely deactivated in response to completion of the offloading.

10. An integrated circuit, comprising:
a first core set including one or more first cores, wherein the first core set is capable of detecting a number of operable phases of a voltage regulator module (VRM) providing power to the first core set;
one or more second core sets coupled to the first core set, wherein each of the one or more second core sets includes one or more second cores;
wherein the first core set is further capable of:
comparing the number of operable phases with a threshold number of operable phases; and
in response to determining that the number of operable phases is less than the threshold number of operable phases, offloading one or more operations performed by the first core set to the one or more second core sets.

11. The integrated circuit of claim 10, wherein the first core set and the one or more second core sets are implemented in different chiplets.

12. The integrated circuit of claim 10, wherein the detecting the number of operable phases of the VRM comprises:
polling the VRM for operational status; and
in response to the polling, receiving a response from the VRM specifying the number of operable phases therein.

13. The integrated circuit of claim 10, wherein the one or more second core sets receive power from one or more second VRMs each including a number of operable phases that is greater than or equal to the threshold number of phases.

14. The integrated circuit of claim 10, wherein each of the one or more second core sets comprises one or reserved cores; and
wherein each reserved core is reserved for performing operations offloaded from another core set supplied with power from a VRM having a number of operable phases that is less than the threshold number of operable phases.

15. The integrated circuit of claim 14, wherein the one or more operations are offloaded to the one or more reserved cores of the one or more second core sets.

16. The integrated circuit of claim 10, wherein the first core set operates at a reduced capacity in response to determining that the number of operable phases is less than the threshold number of operable phases.

17. The integrated circuit of claim 10, wherein one or more cores of the first core set are deactivated in response to completion of the offloading.

18. The integrated circuit of claim 10, wherein the first core set is deactivated in response to completion of the offloading.

19. The integrated circuit of claim 10, further comprising:
a controller coupled to the first core set and the one or more second core sets, wherein the controller is capable of managing the offloading of the one or more operations from the first core set to the one or more second core sets.

20. A computer program product comprising:
one or more computer readable storage media; and
program instructions stored on the one or more computer readable storage media to perform operations comprising:
detecting, by a first core set of an integrated circuit, a number of operable phases of a voltage regulator module (VRM) providing power to the first core set;
comparing the number of operable phases with a threshold number of operable phases defined in the integrated circuit; and
in response to determining that the number of operable phases is less than the threshold number of operable phases, offloading one or more operations performed by the first core set to one or more second core sets of the integrated circuit.
